(19) United States
(12) Patent Application Publication
(10) Pub. No.: US 2011/0181009 A1
(43) Pub. Date: Jul. 28, 2011

(54) SPRING DEFLECTION ADJUSTMENT

(75) Inventors: Dirk Lude, Metzingen (DE); Jurgen Beier, Ulm (DE)

(73) Assignee: GUSTAV MAGENWIRTH GMBH & CO. KG, Bad Urach (DE)

(21) Appl. No.: 12/161,756

(22) PCT Filed: Feb. 23, 2007
(86) PCT No.: PCT/EP07/01601

§ 371 Date: Jul. 22, 2008

(30) Foreign Application Priority Data
Mar. 2, 2006 (DE) 10 2006 010 245.2

(51) Int. Cl. B62K 25/06; F16F 9/02; F16F 9/43

(52) U.S. Cl. 280/65; 267/64.11; 267/64.28

(57) ABSTRACT

A pneumatic spring device (1) for limiting the impact response of a vehicle wheel is provided, with at least one piston-cylinder arrangement (2) which has a piston (3) mounted in an axially displaceable manner in an internal cavity (5) of the cylinder (4), wherein the cylinder (4) is closed at its end regions which face away from each other by end walls (6) which are arranged at a fixed distance from one another. The piston (3) is connected to a piston rod (7) which passes through the end wall (6) and is guided in a sealing manner in the latter, wherein working spaces (8, 8′) which are delimited from each other on both sides of the piston (3) by the piston (3) and are formed as piston space (8) and piston rod space (8′) , which are filled with a compressible medium. The working spaces (8, 8′) can be connected to each other by a connecting device (10). In order to allow a user to change his relative position with respect to the vehicle in a simple manner without the assistance of additional tools and, if appropriate, without having to leave his basic driving position, the spring device is configured in such a manner that the connection of the working spaces (8, 8′) can be controlled by an external actuating element (20), and the connecting device (10) automatically separates the working spaces (8, 8′) after displacement of the piston (3) by at least one predetermined spring deflection.

### BACKGROUND

The invention relates to a spring and/or damping device, particularly for two-wheelers, having at least one piston-cylinder arrangement with working spaces being formed, separated from each other by the piston, as the piston space and piston rod space, which are filled with a compressible spring or damping medium, with the piston being connected to a piston rod, penetrating the end wall of the piston rod space in a sealing fashion.

As a response for a vehicle and/or its wheels to bumps or impacts caused by uneven ground conditions, springs and damping devices have been used for ages in the area of the wheel suspensions. In the meantime, this technology has also been implemented in vehicle driven by muscular strength, such as bicycles, because it considerably improves the general riding comfort, on the one hand, and particularly when the vehicle is used as a sporting device, spring and damping devices are mandatory for mastering difficult landscapes.

In addition to the use of conventional helical springs as spring devices more and more frequently pneumatic springs are used, as known for example from DE 197 37 293 A1. They offer good riding comfort and reduce the overall weight of the vehicle in reference to conventional springs, sometimes quite considerably. The spring devices mentioned are here frequently provided with piston-cylinder arrangements, in which the two working spaces of the device are separated from each other by the piston, as known from example from DE 199 56 321 A1.

The above-mentioned spring devices provide for a certain spring travel, predetermined by the pressure of the system, for the compression and rebounding processes, which amounts to approximately 100 mm, however, they may be considerably higher for special applications. For the user of a vehicle equipped with such a spring device, it may be perhaps necessary under certain conditions or desirable to quickly change its position on the vehicle predetermined by the spring device in order to better cope with an inclined landscape, for example.

### SUMMARY

Therefore, the object is to improve the spring and/or damping device of the type mentioned at the outset such that it allows the user to change its relative position in reference to the vehicle in a simple manner and without applying additional devices and perhaps without having to leave his/her general riding position.

This object is attained through a connection of the working spaces controlled by an external actuating element and a connection device for an automatic separation of the working spaces is provided after the displacement of the piston by a predetermined spring travel.

In a spring device with a compressible medium, beginning with the default rebound position given by the normal spring travel, the working spaces of the spring device can be connected via an actuating element arranged at the outside, causing the spring device to become compressed by at least a part of the body weight of the user putting a strain on said spring device.

After the displacement of the piston by at least a predetermined spring travel the working spaces are then automatically separated so that the spring travel is now shortened and remains in its compressed position by the renewed operation of the actuating element, also resulting in the active separation of the working spaces. The spring travel of the spring device is shortened this way, while the vehicle part located above the wheel and the spring device including the body parts of the user, for example the handlebar, including the arms and upper body of the user, change their relative position and are located in a position closer to the ground. A subsequent renewed operation of the actuating element relaxing the spring device allows it to return to the original rebound position.

Advantageously, to produce an enlarged operating volume at the side of the piston rod, in a further embodiment of the device this piston rod is provided with an internal cavity which is connected to the piston rod space via a penetrating opening arranged in the lateral wall of the piston rod such that the medium can pass through this penetrating opening between the internal cavity of the piston rod and the piston rod space and both spaces can form a respective working space.

In another advantageous embodiment according to the invention, to ensure a secure connection of the two working spaces, the connection device is provided with a fixed end, connected to the end section of the cylinder in the piston space, and a free end, engaging the piston rod space. In order to securely guide the free end of the connection device during the occurring spring processes, it may be beneficial to provide in another embodiment to arrange a limiting tube in the internal cavity of the piston rod, with its opening at the end engaging the free end of the connection device in a sealing fashion.

A connection device, produced particularly easily and reliably, is realized in a preferred embodiment of the invention such that the connection device is embodied as a connection tube, guided in a sealing fashion parallel in reference to the longitudinal axis of the cylinder, particularly coaxially, inside the piston. In order to allow for the volumes of the working spaces to communicate with each other, in a particularly preferred embodiment of the device, the connection device is provided with at least one penetrating opening for the medium in its section located inside the piston rod space, at its walls, so that when respective locking members are opened a pressure equalization can occur via the connection devices between the working space filled with the medium. Several, individually sealed penetrating openings may be provided at the connection device to realize different settings of the spring travel.

When the connection between the working spaces has been established and after the spring device has been filled with the medium, this connection is separated and the spring device is ready to use. In a spring process triggered by an impact, the spring device is compressed, i.e. the pressure inside the working space allocated to the piston space is increased while the working space allocated to the piston rod space is reduced. The resulting forces counteract the triggering impact and reestablish the equilibrium between the working spaces. If the spring travel is shortened for the above-mentioned reasons, a connection of the volumes of the working spaces is made via the external actuating element; by the subsequent load being applied on the spring device, for example by the body weight of the user, a volume exchange between the two volumes occurs via the connection tube of the connection element until the penetrating openings of the connection device, with its free end being guided in the limiting tube, passes over the seal of said limiting tube and thus automatically separates the two volumes. Any further compression of the spring device leads to no additional pressure compensation and the relatively small volume of the connection tube, allocated to the volume of the piston space when the connection between the working spaces are opened, has practically no influence on the pressure ratios. The active separation of the volumes at the actuating element leads to the different surfaces at the piston side and the piston rod side adjusting to a different equilibrium of forces, in which the fork rebounds. Now, as intended, the spring travel is reduced in reference to the original spring travel.

In order to return to the full spring travel at a later time, the actuating element is activated once more, simultaneously releasing the spring device, and thus once more connecting the working spaces. Due to the different surfaces at the piston and the piston rod side as well as the weight of the wheel engaging the spring device the spring device once more rebounds to its full extent, providing the entire spring travel of the spring device after another operation of the external actuating element and the separation of the working spaces connected thereto.

In order to allow design of the compression and/or rebounding process to be even more comfortable for the user of the spring device, it may be provided in another embodiment that between the piston and the end walls of the cylinder at least one additional spring element is arranged, supporting the compression and/or rebounding motion of the spring device, so that the spring device is allowed either to react faster to a desired shortening or an extension of the spring travel when the volumes are connected or to achieve an overall more sensitive reaction of the spring device for compensating impacts.

In a further embodiment of the invention, the cylinder is beneficially provided with an accepting device at its end section allocated to the piston space, which accepts the actuating element as well as the fixed end of the connection device and connects them to each other in order to ensure a reliable connection and separation of the working spaces and a secure arrangement of the connection devices within the spring device.

In order to reliably connect the volumes of the two working spaces to each other and to allow their respective separation in another embodiment of the invention the spring device is provided such that the actuating element is provided with a blocking member, which connects or separates the working spaces. It may be formed by a valve, for example, which opens or closes an opening connecting the volumes via a rotary pin provided with a seal. Additionally, in another embodiment it is suggested for the actuating element simultaneously to be used as the access to fill the volumes with the medium, and for this purpose the actuating element may be provided with a valve accessible from the outside to fill the working spaces with the medium.

In order to reliably trigger the respectively desired control process by the user, in another embodiment the actuating element is provided with at least one actuator arranged at the exterior face of the cylinder. In this arrangement, the actuating element is easily and securely accessible by the user without having to leave his/her position on the two-wheeler, so that a change of the spring travel is possible during the ride as well.

A useful embodiment may provide for the actuator to be embodied as a crown-shaped rotary knob or push button, preferably provided with contact supports. Such a crown-shaped knob arranged at the exterior end wall of the cylinder is easily accessible and operable by the user, because it only need to be rotated or pushed to trigger a desired operation. Contact supports in the form of depressions or recesses on a button enhancing the motion of the actuator additionally facilitate the operation. An additional operating support, providing even better comfort because the user no longer has to bend down to the position at the end wall of the cylinder, is represented by an actuating element of a useful further development of the spring device, which is provided with at least one additional actuator arranged at a distance from said cylinder. This actuator may be a button or a rotational ring arranged at the handlebar of the two-wheeler or its stem, which triggers the function of the actuating element equally reliably as the actuator arranged at the cylinder. The actuator arranged at the handlebar or the stem represents a so-called remote control.

With regard to a simple operation of the spring device and to allow a simple adjustment to the desires and needs of the user, it is advantageous for the medium of an embodiment of the spring device to preferably comprise nitrogen or air, because one of them represents a now relatively easily available inert gas and the other medium, namely air, allows the user independently and at any time, using an air pump frequently carried along, to adjust the pressure conditions of the working spaces and thus the spring characteristics to his/her liking.

In order to compensate the impacts to be compensated by the spring device it has proven beneficial, in the sense of a simple and industrial-scale production, to develop an embodiment of the spring device with a cylinder having an essentially circular cross-section, however, other embodiments of the spring device are also possible, for example when unusual lateral forces have to be compensated or for esthetic reasons, showing a cross-section deviating therefrom, for example an elliptic or multi-faceted one.

Based on the obvious combination of spring devices with damping devices in a unit arranged at the vehicle wheel an embodiment of the spring device is particularly preferred in which it represents a part of a fork leg of a fork to hold the wheel particularly provided for a two-wheeler, and in which at the other fork leg of said fork a damper is arranged, preferably embodied as a gas damper, to dampen vibrations. This way, the user of the spring device can be ensured of an optimal riding comfort with his/her vehicle, because by the use of simple means he/she is able to independently influence the characteristics of the spring and damping devices, which can be adjusted to the respective environmental conditions practically at any time.

### BRIEF DESCRIPTION OF THE DRAWINGS

In the following, the invention is explained in greater detail based on exemplary embodiment, using the figures in the drawing.

Shown, partially in a schematic illustration:

FIG. 1 a side view of an exemplary embodiment of a spring device according to the invention with an adjustable spring travel in the rebound position, with the connection of the two working spaces being closed;

FIG. 2 a side view of a spring device of FIG. 1 in the compressed position, with the connection of the two working spaces being open;

FIG. 3 a detailed view of a section of a spring device in the position of FIG. 2; and

FIG. 4 a top view, partially in section, of a spring device as a part of a fork leg of a fork provided for a two-wheeler.

### DETAILED DESCRIPTION OF THE PREFERRED EMBODIMENTS

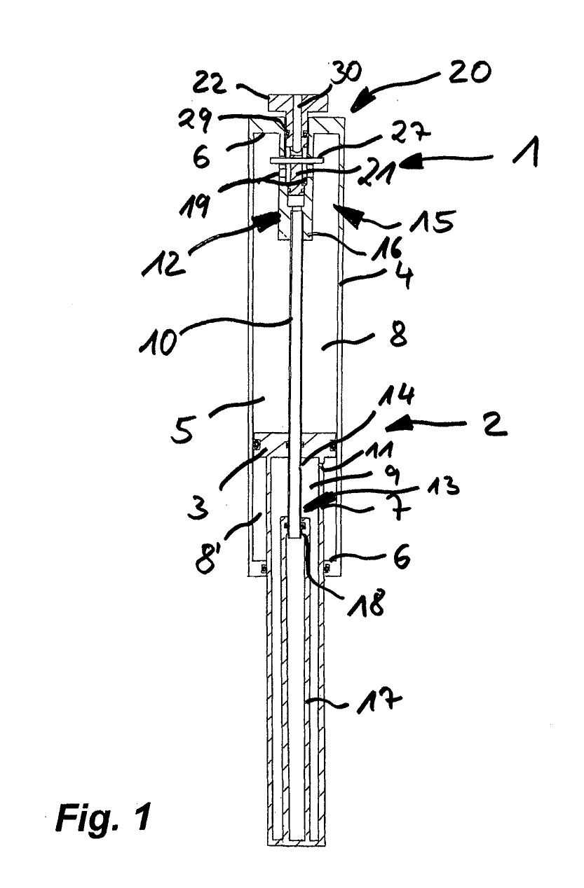

FIGS. 1 through 4 show a pneumatic spring device, in its entirety marked 1 in the exemplary embodiment, to limit the response of a vehicle wheel to an impact. Firstly referring to FIG. 1, in which the spring device 1 is shown in its completely rebounded position and with working spaces 8, 8′ not being connected, the spring device 1 is provided with a piston-cylinder arrangement 2, which is provided with a piston 3 arranged in a cylinder 4 in an axially displaceable manner, both having an essentially circular cross-section. The cylinder 4 is closed at its end sections facing away from each other by end walls 6 arranged at a fixed distance in reference to each other, with the piston 3 being connected to a piston rod 7 penetrating the end walls 6 and guided therein in a sealing fashion. At both sides of the piston 3, working spaces and/or volumes 8, 8′ are formed as piston space 8 and piston rod space 8′, separated by the piston 3, and filled with a compressible medium. The working spaces 8, 8′ can be connected to each other via a connection device 10. In order to comfortably adjust the spring travel of the spring device 1 and correspondingly the adjustment of a relative position of the piston 3 and the cylinder 4 different from the one shown here, the connection of the working spaces 8, 8′ can be controlled by an external actuating element 20 and the connection device 10 can separate the working spaces 8, 8′ by at least one predetermined spring travel after displacing the piston 3.

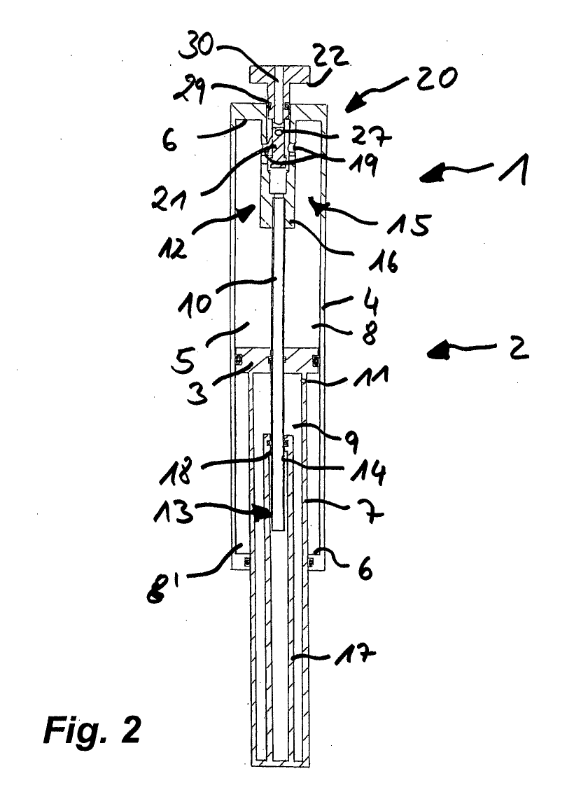

Furthermore, it is discernible from FIGS. 1 and 2 that the piston rod 7 is provided with an internal cavity 9, which is connected to the piston rod space 8′ via a penetrating opening 11 arranged at the side wall of the piston rod 7, so that the two spaces combined form the working space 8′ and the medium fills the entire working space 8′ via the penetrating opening 11. Within the internal cavity 9 of the piston rod 7 a limiting tube 17 extends over the largest part of the length of the piston rod, again coaxial in reference to the longitudinal axes of the cylinder 4 and the piston rod 7, which is provided with an opening 18 at its end facing the piston 3, which is engaged in a sealing fashion by the free end 13 of the connecting device 10.

The connection device 10 is embodied as a connecting tube 10, parallel and coaxial in reference to the longitudinal axis of the cylinder 4, sealing the piston 3. The connection tube 10 is provided with a fixed end 12, connected to the end section of the cylinder 4 in the piston space 8, and a free end 13 engaging the piston rod space 8′. At its section located in the piston rod space the connection device 10 is provided at its wall with a penetrating opening 14 for the medium. In order to fix the connection device 10 in the cylinder 4 and to connect it to the actuating device 20 the spring device 1 is provided with a receiving device 15. This device is embodied as a cylindrical connection piece 16, coaxial in reference to the longitudinal axis of the cylinder 4, and receives in its opening, facing the piston 3 and not shown in greater detail, the fixed end of the connection device 10 formed by the connection tube 10. At the end facing away from the piston 3 the actuating element 20 is located, which in cooperation with the actuator 22 can control the connection of the two working spaces 8, 8′ and thus their volumes via a blocking member 21 being a type of valve, arranged at the external end of the cylinder 4.

While FIG. 1 shows the spring device 1 in a rebounded position, the spring device in FIG. 2 is discernible in the compressed position. In the not-operated position in FIG. 1, the blocking member 21 locks the penetrating opening 19, which creates the connection between the working space 8 and the connecting tube 10. Simultaneously, by the penetrating openings 11 and 14 the internal cavities 9 of the piston rod 7 and the piston rod space 9 are connected to the working space 8′, and in this state the volume of the connecting tube 10 is also allocated to said working space 8′. Operating the actuating element 20 by manually adjusting the actuator 22, as discernible in FIG. 2, opens the penetrating opening 19 and connects the two working spaces 8, 8′ such that pressure compensation can occur between them. When simultaneously loading the spring device 1 is strained from the direction of the actuating element 20 and the piston 3 penetrates further into the cylinder 4 by a support, not shown in greater detail. Here, the free end 13 of the connection tube is further displaced in the interior area of the limiting tube 17, namely to such an extent that within the scope of this motion the penetrating opening 14 of the connecting tube 10 passes the opening 18 of the limiting tube 17, closing it in a sealing manner, and thus automatically separating the connection of the working spaces. At this time the volume of the connecting tube is allocated to the working space 8 due to the connection released at the actuating element 20. As a result, by this process the spring travel of the spring device 1 has been reduced by a predetermined amount, for example by one fourth of the overall spring travel. Depending on the embodiment of the device, here one or more additional reduction amounts are possible as well.

A subsequent operation at the actuating element 20 leads to an active separation of the working spaces 8, 8′ so that subsequently the spring device remains in the compressed position, providing only a limited spring travel. Only a renewed opening of the blocking member 21 at the actuating element 20 allows the spring device 1 to return to the rebounded position with a releasing effect.

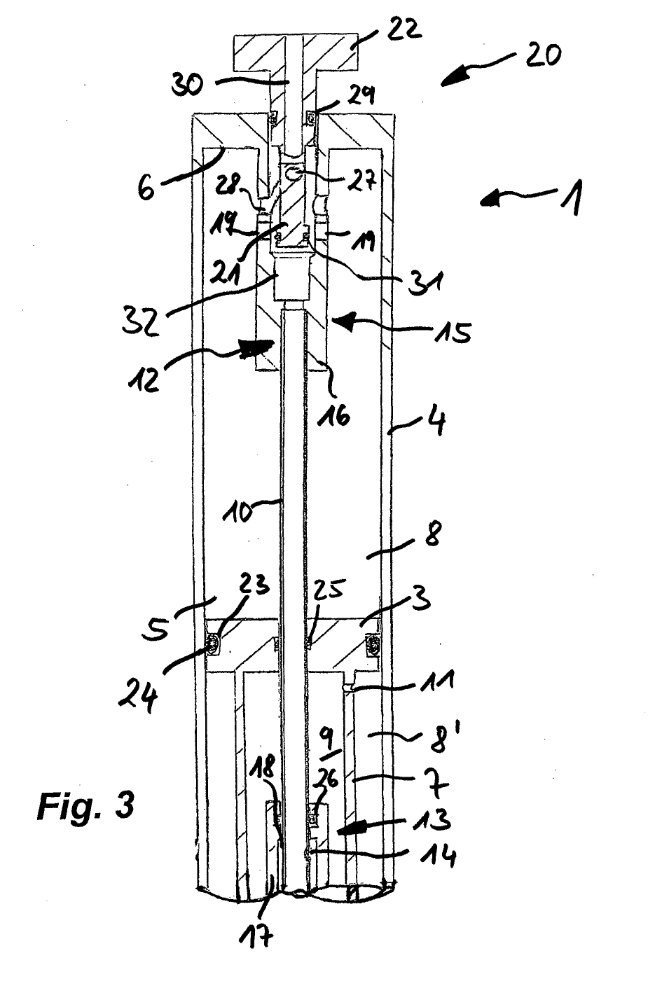

FIG. 3 shows a section of the position of the spring device 1 shown in FIG. 2, so that reference is made to the above-mentioned embodiment of said figure. In this figure, the sealing guidance of the piston 3 in the cylinder 4 is better discernible with its seal 24 arranged in a circumferential groove 23, the sealing guidance of the connection tube 10 in the piston having a seal 25, as well as the also sealing guidance of the free end 13 of the connection tube 10 in the opening 18 of the limiting tube 17 via the seal 26 located there. Additionally, in FIG. 3 the functionality of the actuating element 20 is shown in greater detail. The actuator 22 is arranged as a crown-like rotary knob at the external side of the facial wall 6, another actuator 22′, arranged at a distance from the cylinder, is not shown. Operating the actuating element 20 at the actuator 22 lifts the flange-like lid thereof further off the exterior side of the end wall 6, while the pin-shaped end piece of the lid, accepted in the opening direction 15, is guided further outward in the receiving direction 15, with the seal 29 ensuring a gas-tight boundary towards the internal space. A feeder 30 penetrating the actuator 22 is provided with a valve, not shown in detail, so that the working spaces 8, 8′ of the spring device 1 can be filled from the outside. The actuator 22 is additionally connected to a blocking member 21 embodied as a valve pin, which in turn is penetrated by a guiding pin 27. This pin glides in a curved guide bar 28, so that the motion of the operating elements always occurs in a reproducible manner. An already mentioned operation of the actuating elements 20 to release the connection between the working spaces 8, 8′ allows here for the guidance pin 27 to be displaced upwards in the guide bar 28, with the end of the blocking member 21, facing the piston 3, being lifted off its seat in the entry area 32 of the fixed end 12 of the connecting tube, again sealed by a seal, and establishing a connection of the working spaces 8, 8′ of the spring device 1 and allowing an exchange of the medium between the working spaces 8, 8′.

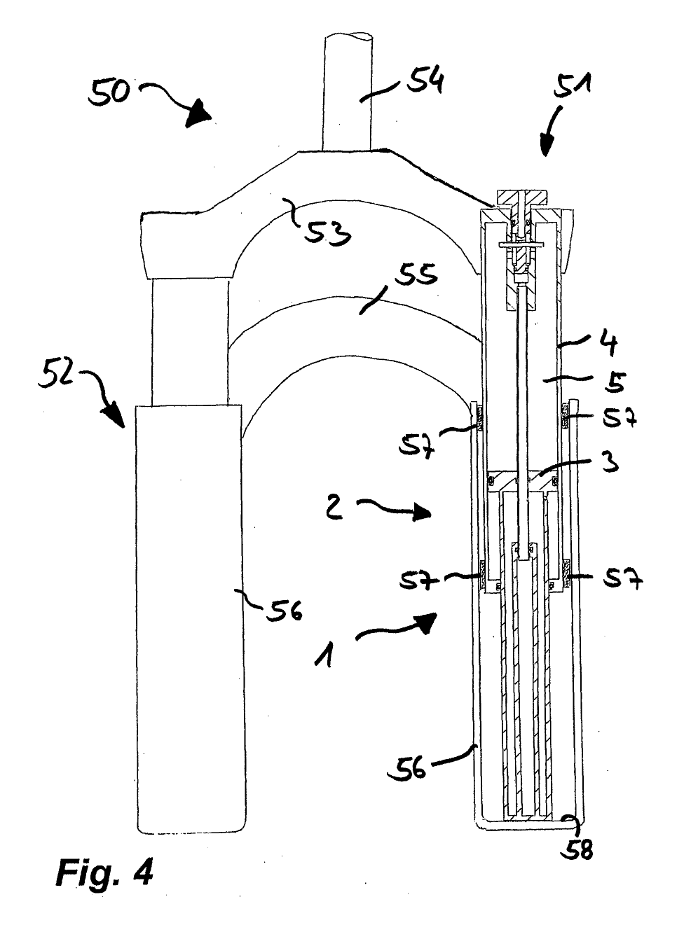

Finally, for better clarity FIG. 4 shows an arrangement of the spring device 1 as a part of a fork leg 51 of a fork 50, particularly provided for a two-wheeler, to hold a respective wheel, not shown here, which is held with its hub at the fork 50 via a hub receiver, also not shown. A damper is arranged to compensate vibrations at the other fork leg 52 of the fork 50, not shown in greater detail, preferably embodied as a gaseous damper, friction damper, oil damper, or the like. Additionally, the fork 50 is provided with the fork bridge 53 connecting the fork legs 51, 52, and originating therefrom with the shaft tube 54, which creates the connection to the frame of the two-wheeler. For stabilizing purposes, between the fork legs 51, 52 preferably at least one arc-shaped bent stabilizer 55 may be arranged, as well. It is easily discernible that each of the fork legs 51, 52 is provided with an insertion tube 56, into which a so-called stand pipe is inserted. In case of a spring device 1 according to the invention, this stand pipe is formed by a cylinder 4 of the piston-cylinder arrangement 2. In a springing process, the stand pipe inserts into the dip pipe 56, for this purpose being supported at friction bearings 57 arranged between the tubes. Additionally, it is discernible from FIG. 4 that the bottom of the piston rod 7 together with the limiting tube 17 having a common bottom, which can be supported at the bottom 58 of the dip pipe 56 when the cylinder 4 inserts into the dip pipe 56.

Therefore, the above-described invention also relates to a spring and/or damper device, embodied in the exemplary embodiment as a pneumatic spring device 1. It serves to limit the impact response of a vehicle wheel having at least one piston-cylinder arrangement 2, which is provided with a piston 3, supported in an axially displaceable manner in an interior cavity 5 of the cylinder 4, with the cylinder 4 at its end sections, facing away from each other, being closed by end walls 6 arranged at a fixed distance from each other, with the piston 3 being connected to a piston rod 7 penetrating one of the end walls 6 and guided in it in a sealing fashion, with working spaces 8, 8′ being located on both sides of the piston 3, formed as the piston space 8 and the piston rod space 8′ which are separated from each other by the piston 3, and filled with a compressible medium, and with the working spaces 8, 8′ being connected to each other by a connection device 10. By changing the spring travel of the spring device 1 a user of the above-mentioned spring device 1 has the ability to adjust the position of a vehicle part, particularly the stem with the handlebar, to the conditions of the terrain such that the connection of the working spaces 8, 8′ can be controlled by an external actuating element and that the connection device 10 automatically separates the working spaces 8, 8′ after a displacement of the piston 3 by at least a predetermined spring travel.

In the exemplary embodiment, the application of the invention is shown using a conventional telescopic fork. Alternatively, the invention can also be used in so-called upside down telescopic forks. However, the invention is not limited to the application of the telescopic fork, but it is also possible to use it with any other type of spring and/or damping elements, i.e. spring forks, dampers, spring legs, and the like according to the invention.

1. A spring device (1) for two-wheelers, comprising at least one piston-cylinder arrangement (2), with working spaces (8, 8′) separated from each other by a piston (3) that form a piston space (8) and piston rod space (8′), which are filled with a spring or damping medium, the piston (3) is connected to a piston rod (7) that penetrates an end wall (6) of the piston rod space (8′) in a sealing fashion, a connection of the working spaces (8, 8′) is controlled by an external actuating element (20) and a connection device (10) for an automatic separation of the working spaces (8, 8′) is provided after displacement of the piston (3) by a predetermined spring travel.

2. A spring device according to claim 1, wherein the piston rod (7) has an internal cavity (9), which is connected to the piston rod space (8′) via a penetrating opening (11) arranged in a side wall of the piston rod (7).

3. A spring device according to claim 1, wherein the connection device (10) is provided with a fixed end (12) connected with an end section of the cylinder in the piston chamber (8) and a free end (13) engaging the piston rod space (8′).

4. A spring device according to claim 3, wherein a limiting tube (17) is arranged in the internal cavity (9) of the piston rod (7), with a free end (13) of the connection device (10) engaging an end opening (18) of the limiting tube in a sealing fashion.

5. A spring device according to claim 1, wherein the connection device (10) comprises as a connecting tube guided in the piston (3) in a sealing fashion parallel in reference to a longitudinal axis of the cylinder (4).

6. A spring device according to claim 1, wherein the connection device (10), in a section located in the piston rod space (8′), is provided at its walls with at least one penetrating opening (14) for the spring or damping medium.

7. A spring device according to claim 1, wherein between the piston (3) and one of the end walls (6) of the cylinder (4) at least one additional spring element is arranged, supporting at least one of a compression or a rebounding of the spring device (1).

8. A spring device according to claim 3, wherein the cylinder (4) in the end section allocated to the piston space (8) is provided with a receiving device (15), which receives the actuating element (20) as well as the fixed end (12) of the connection device (10) and connects them to each other.

9. A spring device according to claim 1, wherein the actuating element (20) is provided with a blocking member (21), which connects or separates the working spaces (8, 8′).

10. A spring device according to claim 1, wherein the actuating element (20) is provided with a valve that can be operated from outside for filling the working spaces (8, 8′) with the spring or damping medium.

11. A spring device according to claim 1, wherein the actuating element (20) is provided with at least one actuator (22) arranged at an external end of the cylinder (4).

12. A spring device according to claim 11, wherein the actuator (22) comprises a crown-shaped rotary knob or push button provided with contacting supports.

13. A spring device according to claim 11, wherein that the actuating element (20) comprises at least one additional actuator (22′) arranged at a distance from the cylinder (4).

14. A spring device according to claim 1, wherein the medium serving for at least one of compensating or damping purposes comprises nitrogen or air.

15. A spring device according to claim 1, wherein the cylinder (4) has an essentially circular cross-section.

16. A spring device according to claim 1, further comprises a fork leg (51) of a fork (50) for a two-wheeler in which the spring device is formed or located, and for damping vibrations a damper is arranged at the other fork leg (52) of said fork (50).
